(19) United States
(12) Patent Application Publication
(10) Pub. No.: US 2016/0267545 A1
(43) Pub. Date: Sep. 15, 2016

(54) AUTOMATICALLY TARGETING CONTENT TO ONLINE USERS

(71) Applicant: LinkedIn Corporation, Mountain View, CA (US)

(72) Inventors: Russell M. Glass, Belmont, CA (US); Donald E. Flood, Oakland, CA (US); Christopher L. Mann, Fairfax, CA (US); Sachin Rekhi, Menlo Park, CA (US)

(21) Appl. No.: 14/815,873

(22) Filed: Jul. 31, 2015

Related U.S. Application Data
(60) Provisional application No. 62/131,144, filed on Mar. 10, 2015.

(51) Int. Cl. G06Q 30/02; G06Q 50/00; H04L 29/08

(52) U.S. Cl. CPC G06Q 30/0269; H04L 67/10; H04L 67/02; G06Q 50/01

(57) ABSTRACT

A system and method for automatically targeting online users are provided. A user performs an action that exhibits an interest in a product/service or performing a certain action, such as making a charitable contribution. A user record is created in a user management system, such as a customer relationship management database. The user record is augmented with additional data, such as data from a user profile, of the user, in a social network. Examples of such data include employer information, friend information, academic history, and job title. The augmented user record is provided to a targeted content system that assigns the user to a nurture flow that includes multiple segments, each segment associated with actions to perform relative to the user, such as sending certain content to the user through one or more delivery channels.

### CROSS-REFERENCE TO RELATED APPLICATIONS

This application claims the benefit of U.S. Provisional Application No. 62/131,144, filed Mar. 10, 2015, the entire contents of which is hereby incorporated by reference as if fully set forth herein, under 35 U.S.C. §119(e).

This application is related to (1) U.S. patent application Ser. No. XX/YYY,ZZZ, [Attorney Docket No. 60352-0074] filed the same day herewith; (2) U.S. patent application Ser. No. 14/218,413 filed Mar. 18, 2014 entitled “Business Audience Marketing System”; and (3) U.S. patent application Ser. No. 14/294,992 filed Jun. 3, 2014 entitled “Dynamic Advertisement Pricing System”, the entire content of each of which is incorporated by this reference for all purposes as if fully disclosed herein.

### FIELD OF THE DISCLOSURE

The present disclosure relates to automatically targeting content to online users and, more specifically, to automatically nurturing users who have expressed an interest in performing a certain action or in purchasing a product or service.

### BACKGROUND

Companies target information to potential customers to show how people may benefit from products or services provided by the companies. A company may target information to a large group of users regardless of whether the users have interacted with the company or otherwise expressed interest in a product or service provided by the company. Such an approach has the disadvantage of wasting resources (e.g., time and money) on people who have no interest in becoming a customer of the company. Some companies maintain email lists of users who have provided their respective email addresses to the companies. Such an approach has the benefit of targeting people who have a higher likelihood of becoming a customer. However, emails have limited reach and impact due to email filters and people generally ignoring email communications from sources other than close friends or associates. Additionally, very little information is known about people on email lists other than their names and email addresses. Therefore, each user on an email list is effectively treated the same as every other user on the same email list.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example system for targeting content to users, in an embodiment;

FIG. 2 is a block diagram that depicts multiple components of a targeted content system, in an embodiment;

FIG. 3 is a block diagram that depicts example nurture flows, in an embodiment;

FIG. 4 is a flow diagram that depicts an example process for automatically targeting content to a user, in an embodiment;

FIG. 5 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Techniques are provided for automatically targeting content for a set of users. The set of users may be identified based on the users exhibiting interest in a certain product or service or performing a particular action. The targeted content for each user may be determined based on attributes of the user and/or actions that the user has previously performed. The targeted content may be intended to show, to the user, the benefit that may be derived from the product/service or performance of the particular action.

In an embodiment, a user fills out a form on a web page, where the filled-out form includes information about the user, such as the user's name, email address, and social network identifier. The user information is stored in a customer relationship management database to allow a sales representative to view progress of the user towards a particular action, such as purchasing a product or service. The user information is augmented with additional information from one or more social networks to which the user belongs. The augmented user information is provided to a system that manages the targeting of content to multiple users. The system assigns the user to a nurture flow that the sales representative (or another person affiliated with the sales representative) establishes. The nurture flow includes multiple segments, each segment corresponding to a different step in a marketing plan. The segment to which a user is assigned dictates the content and, optionally, the delivery channel through which the content will be presented to the user. As a user is assigned to successive segments in a nurture flow, which additional content and how the additional content will be delivered may change. The nurture flow is designed to direct or focus a user toward performing a particular action.

### System Overview

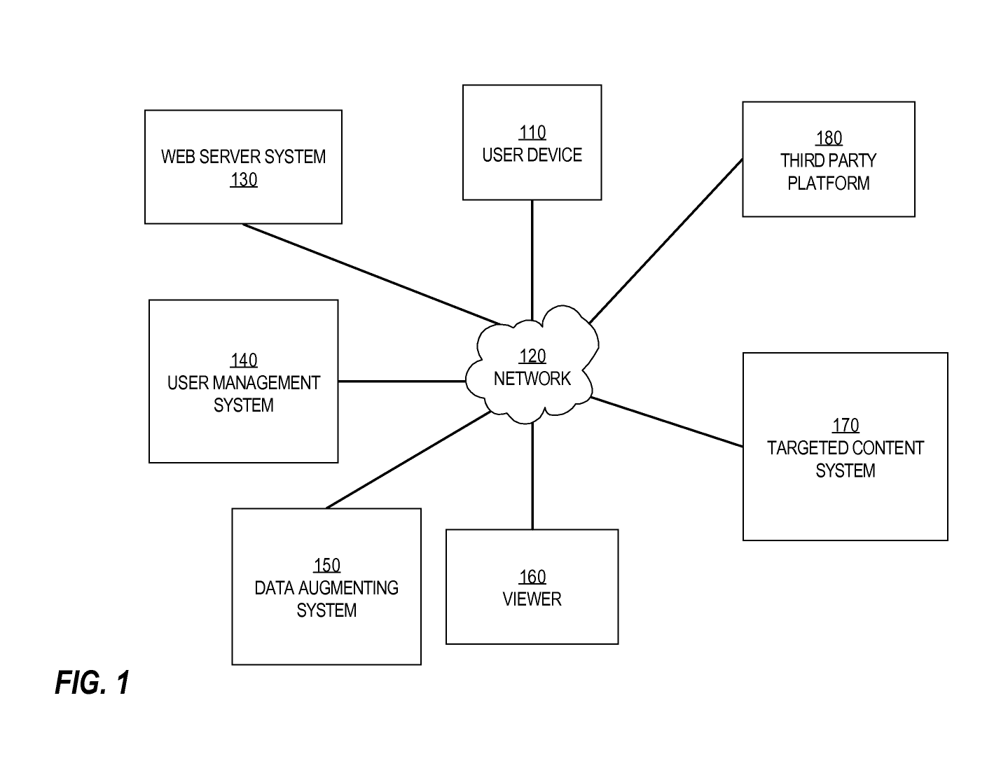

FIG. 1 is a block diagram that depicts an example system 100 for targeting content to users, in an embodiment. System 100 includes a client device 110, a network 120, a web server system 130, a user management system 140, a data augmenting system 150, a viewer 160, a targeted content system 170, and a third party platform 180.

Client device 110 is any computing device that is configured to communicate with web server system 130 over network 120. Examples of client device 110 include desktop computers, laptop computers, tablet computers, and smartphones. Client device 110 may execute multiple applications, such as web browsers and applications that are configured to communicate with a dedicated set of servers. Although only a single client device 110 is depicted, system 100 may include many client devices, each of which is configured to interact with web server system 130 or third party platform 180.

Network 120 may be implemented on any medium or mechanism that provides for the exchange of data between client device 110 and web server system 130. Examples of network 120 include, without limitation, a network such as a Local Area Network (LAN), Wide Area Network (WAN), Ethernet or the Internet, or one or more terrestrial, satellite or wireless links.

Each of web server system 130, user management system 140, data augmenting system 150, viewer 160, targeted content system 170, and third party platform 180 may be implemented in hardware, software, or a combination of hardware and software. Each of these components in system 100 may be implemented on a single computing device or multiple networked computing devices. Such a computing device may rely on third party services to perform certain functions, such as a storage service.

Web server system 130 provides a web site that users are able to visit and view using (e.g., web) browsers executing on client devices, such as. Web server system 130 provides web pages (static and/or dynamic) in response to requests from the browsers. Web server system 130 may provide content that educates web site visitors regarding one or more products and/or services that web site visitors may purchase, lease, or otherwise use, at least for a limited time if not indefinitely.

### User Management System

User management system 140 includes a database that stores information about users that have visited a web site provided by web server system 130. Some of the users may be users that filled out a form, such as one that includes fields for name, email address, mailing address, phone number, social network identifier, etc. Such users are referred to herein as “known contacts.” Web server system 130 is configured to accept the form input and create, in user management system 140, a record that stores the form input. Thus, user management system 140 includes an interface that allows web server system 130 to send data to user management system 140 for persistent storage and that allows other computing devices or systems to request data from the persistent storage.

Some users identified in user management system 140 may be users that merely visited the web site but did not fill out any form. Such users are referred to herein as “anonymous contacts.” Although an anonymous contact did not explicitly provide personal information to web server system 130, web server system 130 may store data that identifies the user in an indirect way, such as browser data that identifies user's browser that the user employed to visit the web site or device data that identifies the computing device that executes the browser.

Some users identified in user management system 140 may be users that have not visited the web site provided by web server system 130 or at least it is not known that they have visited the web site. For example, an individual affiliated with user management system 140 may have met a person at a networking event and exchanged business cards with that person. The individual then provides the business card information to a computing device (e.g., through text or voice input) and causes the business card information to be entered into user management system 140. Thus, user records may be created using a manual process.

A user record stored in user management system 140 includes one or more data items, such as the user's first and last name, a device ID that identifies a client device that the user operated when accessing web server system 130, one or more social network IDs, each of which uniquely identifies the user relative to other members of the same social network, one or more action IDs, each of which identifies and, optionally, describes an action that the user has performed, and/or a stage ID that identifies a particular stage to which the user is assigned.

For example, user management system 140 may have pre-defined (and customized) stages to which a user may be assigned. Each stage corresponds to a different stage in a sales process. Example stages include early discussions, RFP (request for proposal) or active discussions, negotiation and review, closing, and delivery. For forecasting purposes, each stage may be associated with a likelihood of arriving at the closing stage or delivery stage. Also, each stage may be associated with a dollar amount that is based on the value of closing of a deal for a company and the likelihood of success. For example, if the value of closing a deal is $2 million and the likelihood of closing the deal is 75%, then the value of the user or prospect is $1.5 million.

The entity or party that owns or operates web server system 130 may or may not be the same as the entity or party that owns or operates user management system 140.

An example of user management system 140 is a customer relationship management (CRM) system. In the context of CRM systems, how user management system 140 is implemented may vary depending on whether the party that owns or operates user management system 140 is targeting content (or marketing) to businesses or to (potential or current) customers. The type of marketing that targets businesses is referred to as “B2B” while the type of marketing that targets customers or consumers is referred to as “B2C.” Thus, B2B marketing may operate much differently than B2C marketing. B2B companies typically have much smaller contact databases than B2C. Also, the number of sales in B2B may be much smaller than the number of sales in B2C. Also, relationships in a B2B environment are generally built over a longer time relative to relationships in a B2C environment. However, the techniques described herein may be applied in both environments.

While only a single user management system 140 is depicted in FIG. 1, system 100 may include multiple user management systems, each owned or operated by different entities, parties, or companies. Each user management system may be associated with a different web server system. Also, each different user management system may rely on the services provided by data augmenting system 150 and/or targeted content system 170, each of which is described in more detail below. In other words, data augmenting system 150 may interact with multiple user management systems.

### Data Augmenting System

Data augmenting system 150 is configured to augment (or add to) user data from user management system 140. Data augmenting system 150 then stores the augmented data in data augmenting system 150. Additionally or alternatively, data augmenting system 150 stores the augmented data in user management system 140, if user management system 140 is so configured.

For example, a user record in user management system 140 may include only a person's name and email address. Data augmenting system 150 is configured to read the user record and use the record's data to identify a record or profile in another database of user data, such as a database of a social networking service, such as LinkedIn, Facebook, or Google+. The entity that owns or operates data augmenting system 150 may be a social networking service.

The user data stored in the other database may be from one or more sources, such as multiple social network services. For example, if a user's data (e.g., email address) that is included in a user record matches the corresponding information in a user profile of a social networking service, then the user data is augmented to include information from the user profile. For example, if a user's data only includes a first name, last name, and email address, then the user data may be augmented to include residence information, a mailing address, a phone number, one or more educational institutions attended, one or more current and/or previous employers, one or more current and/or previous job titles, and identities of “friends,” “contacts,” or “connections” of the user, according to one or more social graphs maintained by one or more social networking services.

Augmented data in a single user record may come from multiple sources. For example, job history of a user may come from a first social network service and residence information of the user may come from a different source, such as a second social network service or a different type of source altogether.

User data from user management system 140 may be sent to data augmenting system 150 based on one or more criteria. For example, whenever a record or entry for a new person is created in user management system 140 (and/or whenever a record in user management system 140 is updated), user management system may be configured to automatically send the record/update to data augmenting system 150. In a related example, user management system 140 may periodically send, to data augmenting system 150, a batch of newly-created/updated records, such as every 24 hours. In a related example, user management system 140 may determine to send a batch of newly-created/updated records based on one or more different criteria, such as every 100^{th} newly-created/updated record.

Additionally or alternatively, data augmenting system 150 may operate under a pull model where data augmenting system 150 requests newly-created/updated records from user management system 140. The frequency of such requests may be constant (e.g., every day) or vary based on certain criteria, such as the size of previous batches from user management system 140. For example, if, after requesting batches every day where the batches averaged one hundred records, the latest batch included information about one thousand records, then data augmenting system 150 may begin requesting batches every twelve hours.

In an embodiment, data augmenting system 150 stores, in association with different sets of augmented user data, access data that indicates which users, groups, or devices can access a particular set of augmented user data. For example, if data augmenting system 150 receives (1) first user records from a user management system of company A and (2) second user records from a user management system of company B, then data augmenting system 150 associates (3) the first user records with data that indicates company A and (4) the second user records with data that indicates company B. Thereafter, only users or client devices associated with company A may access the first user records (or the augmented version thereof) and only users or client devices associated with company B may access the second user records (or the augmented version thereof).

Additionally or alternatively, access data indicates how that augmented user data may be accessed, such as read privileges, delete privileges, insert privileges, and update privileges. For example, a user of viewer 160 may be allowed to update augmented user data, such as deleting data items (e.g., a non-working phone number indicated in a user record/profile), adding data items (e.g., a work address), or changing data items (e.g., years worked at a particular company).

### Viewer

Viewer 160 is configured to access data augmenting system 150 to view augmented data. (In an embodiment where system 100 does not include data augmenting system 150, viewer 160 is configured to access user management system 140.) Viewer 160 may be a client device that connects to data augmenting system 150, such as a tablet computer or a laptop computer. For example, viewer 160 may execute an application that is configured to provide a user interface that allows a user of viewer 160 to request and view data from data augmenting system 150. A person operating such a client device may use the augmented data to determine how to interact with a user or set of users identified in the augmented data. Such a person may be a sales representative that desires to have certain content presented to the particular user. The content may be designed to educate the user regarding a value that a product or service may provide to that user specifically or to users generally. The product/service may be provided by an entity or company that the sales representative represents.

In an embodiment, a user of viewer 160 (or viewer 160 itself) is associated with certain access privileges that restrict which data, in data augmenting system 150, that viewer 160 can access. Data augmenting system 150 compares the access privileges of the user or of viewer 160 with access privileges of a set of augmented user data that the user is attempting to access to determine whether the requested access should be granted. For example, viewer 160 may be associated with a read-only option such that a user of viewer 160 may only read augmented user data, of various users, stored in data augmenting system 150. Alternatively, viewer 160 may allow users to update augmented user data, such as deleting data items (e.g., a non-working phone number), adding data items (e.g., a work address), or changing data items (e.g., years worked at a particular company).

If system 100 includes multiple user management systems, each owned/operated by a different entity or company and viewer 160 is associated with only a single entity/company, then data augmenting system 150 may use device/user credentials (e.g., username and password) of a user of viewer 160 to identify the appropriate access privileges and which data the user is able to view. For example, a user of company A using viewer 160 should only be able to access augmented user data that came from a user management system owned/operated by company A.

Thus, while only one viewer 160 is depicted in system 100, system 100 may include multiple viewers. Each user that operates a viewer may have their own user credentials.

In an embodiment, augmented user data of one or more users is only sent from data augmenting system 150 to targeted content system 170 if a user of viewer 160 allows. For example, a sales representative using viewer 160 to view information about multiple users represented in user records from user management system 140. The sale representative may select a strict subset of the users. Only augmented user data of users that are inside the strict subset is sent to targeted content system 170. Alternatively, only augmented user data of users that are outside the strict subset is sent to targeted content system 170. In this embodiment, there is manual control over which sales contacts are automatically “nurtured” by targeted content system.

### Targeted Content System

Targeted content system 170 is configured to receive augmented data from data augmenting system 150 and, based on individual users and their associated attributes indicated in the augmented data, identify content to present to the individual users and/or identify one or more delivery channels through which to deliver content to the individual users. (In an embodiment where system 100 does not include data augmenting system 150, targeted content system 170 may be configured to receive user data from user management system 140.)

Targeted content system 170 may be own or operated by the same or different entity that owns or operates data augmenting system 150. For example, a social network provider may provide both data augmenting system 150 and targeted content system 170. Thus, data augmenting system 150 and targeted content system 170 may execute in the same network or even on the same computing device(s). As another example, a social network provider may provide data augmenting system 150 and a marketing company may provide targeted content system 170.

Augmented data from data augmenting system 150 may be sent to targeted content system 170 based on one or more criteria. For example, whenever a record, profile, or entry for a new person is created in data augmenting system 150 (and/or whenever a record in data augmenting system 150 is updated), data augmenting system 150 may be configured to automatically send the record/update to targeted content system 170.

For example, some user records/profiles in data augmenting system 150 may be associated with target indication data that indicates that the user is to receive targeted content. If any changes are made to a user record that is associated with target indication data, then data augmenting system 150 is configured to send the updated user record (or just the change(s)) to targeted content system 170.

In a related example, data augmenting system 150 may periodically send, to targeted content system 170, a batch of newly-created/updated records. In a related example, data augmenting system 150 may determine to send a batch of newly-created/updated records based on one or more different criteria, such as every 100^{th} newly-created/updated record.

Additionally or alternatively, targeted content system 170 may operate under a pull model where targeted content system 170 requests newly-created/updated records from data augmenting system 150. A request to data augmenting system 150 may indicate specific user records or one or more criteria that a user record must satisfy in order to be sent to targeted content system 170. For example, a request may specify one or more user identifiers that uniquely identify user records. This embodiment is useful if targeted content system 170 already stores data that identifies users that system 170 is currently targeting and needs to determine whether any changes have occurred with respect to those users.

As another example, a request may indicate demographic information, such as “age >35” that age data in a user record must satisfy in order to be sent to targeted content system 170. As another example, a request may request all user records that have changed since the last request from targeted content system 170.

The frequency of requests to data augmenting system 150 may be constant or vary based on certain criteria, such as the size of previous batches from data augmenting system 150. For example, if, after requesting batches every day where the batches averaged one hundred records and the latest batch included information about one thousand records, then targeted content system 170 may begin requesting batches every two hours.

In an embodiment, targeted content system 170 (or data augmenting system 150) is selective in which users are targeted. For example, data augmenting system 150 may send, to targeted content system 170, augmented user records of only users that are associated with a likelihood of performing a certain action that is greater than a particular threshold (e.g., 10%). In a related example, targeted content system 170 performs the comparison for each user record it receives.

### Nurture Flows

Targeted content system 170 assigns a user (indicated in a record) to one or more nurture flows. A nurture flow is a plan for targeting content to a set of one or more users. A nurture flow is divided into progressive segments (or steps) that funnel a user toward performing a particular action, referred to herein as the “intended action.” An example of a plan is a marketing plan and examples of an intended action include viewing certain video content, listening to certain audio content, making a donation to a charitable cause, or performing a conversion (or purchase) on a website associated with web server system 130 or another server system (not depicted).

In an embodiment, one or more successive segments in a nurture flow represent an increase in intensity with which a user is targeted content and/or a change in how the user is targeted. For example, while assigned to a first segment of a nurture flow, a user is sent a first advertisement. After being assigned to a second segment of the nurture flow, the user is sent two advertisements, which may be the same as or different than the first advertisement. Additionally, one or more both of the advertisements may be sent through different channels (e.g., a social network provider, ad platform, etc.) than the channel through which the first advertisement was delivered (e.g., email).

Targeted content system 170 may manage multiple nurture flows. Each nurture flow is associated with a particular entity or organization, such as a marketer. A user may be assigned to multiple nurture flows at the same time, but, in an embodiment, is not associated with more than one segment in a single nurture flow at the same time.

### Nurture Flows from Different Entities

In an embodiment, targeted content system 170 manages multiple nurture flows for different entities. For example, a first marketer establishes a first nurture flow and a second marketer establishes a second nurture flow. In this embodiment, each nurture flow is associated with entity data that identifies the entity that established the nurture flow.

Each user record from data augmenting system 150 (or user management system 140) may also include entity data. Targeted content system 170 may then use the entity data of an incoming user record to determine to which nurture flow (or set of nurture flows) the user is assigned (or should be assigned, if not already).

If the user represented in the user record is already represented in a database of targeted content system 170, then the user may already be assigned to a nurture flow. The database may be divided based on entity, such that user records of users that are targeted by one entity (or marketer) are stored separately from user records of users that are targeted by another entity. A user may targeted by multiple entities. Thus, targeted content system 170 may store multiple user records for the same user, each user record being assigned to a different nurture flow.

If, for example, targeted content system 170 determines that the user represented by an incoming user record is not yet assigned to a nurture flow, then targeted content system 170 creates, in a database, a record for the user and associates the record with a nurture flow that is associated with the identified entity or marketer.

### Nurture Flow Assignment Criteria

If an entity is associated with multiple nurture flows, then targeted content system 170 may determine to which nurture flow an incoming user record (e.g., from data augmenting system 150 or user management system 140) should be assigned. Targeted content system 170 analyzes a user record and one or more “nurture flow assignment criteria” associated with each of multiple nurture flows to determine to which of the multiple nurture flows the corresponding user is to be assigned. An example of a nurture flow assignment criterion is an entity identifier and/or nurture flow identifier. For example, an incoming user record may indicate a particular entity (or company or marketer) and/or a particular nurture flow. As a specific example, a particular user record from a particular user management system may contain a particular entity identifier that identifies the particular entity. Then, after the particular user record is augmented by data augmenting system 150, a user of viewer 160 (displaying user records from data augmenting system 150) provides input that associates the particular user record with a particular nurture flow previously created by the particular entity. In this way, targeted content system 170 selects the appropriate nurture flow from the set of nurture flows associated with the entity identified by the particular entity identifier.

Another example of a nurture flow assignment criterion is a set of one or more attributes of a user. For example, targeted content system 170 may compare user information in an incoming user record with nurture flow assignment criteria associated with each nurture flow. As a specific example, if a user record indicates that the corresponding user is a high-level executive, then the user record is assigned to a first nurture flow. If a user record indicates that the corresponding user is unemployed, then the user record is assigned to a second nurture flow that is different than the first nurture flow. If a user record indicates that the corresponding user is female, over 30 years of age, and lives in the Pacific Northwest, then the user record is assigned to a third nurture flow. Thus, different nurture flows may be associated with different nurture flow assignment criteria. If nurture flow assignment criteria of multiple nurture flows are satisfied, then a matching nurture flow may be randomly selected or displayed to a user (e.g., of viewer 160) for manual assignment.

In addition to employment history or demographic information, another example of a user attribute is a user having performed a certain action (such as visiting a particular web page or web site), and then the user record is assigned to a particular nurture flow. Thus, different actions may be associated with different nurture flows.

Another example of a user attribute is the stage to which a user is currently assigned, as indicated in user management system 140 and reflected in an incoming user record. The stage may be a stage in a sales cycle. Thus, the stage a user is in may dictate which of multiple possible nurture flows to which the user will be assigned.

A different nurture flow may be established for each stage of a sales cycle. Thus, user management system 140 may send, to targeted content system 170 (directly or indirectly through data augmenting system 150), stage advancement data that indicates that a particular user has advanced from one stage to another stage. In response, targeted content system 170 may reassign the particular user from a first nurture flow to a second nurture flow that is associated with the other stage, even before the user performs the intended action associated with the first nurture flow.

Additionally or alternatively, targeted content system 170 may receive success data that indicates a likelihood of a user closing a deal and/or a dollar amount reflecting the amount of the deal (e.g., $2 million) and the likelihood of closing (e.g., 75%). Such success data may come from user management system 140 or from data augmenting system 150. The success data may be used to assign a user to a certain nurture flow if there are multiple nurture flows from which to select.

### Creating Nurture Flows

An entity (not depicted) may establish a nurture flow to be managed by targeted content system 170 in one of multiple ways. For example, a marketer may define multiple (or all) attributes of a nurture flow using a user interface displayed, on a client device operated by the marketer, by a web application provided by targeted content system 170. Example nurture flow attributes include a number of segments in the nurture flow, an intended action of the nurture flow, targeting parameters (described in more detail below) for each segment in the nurture flow, and segment advancement criteria (also described in more detail below) for each segment in the nurture flow.

As another example, a marketer may select (e.g., using a user interface displayed by a web application provided by targeted content system 170) a nurture flow from among multiple “default” nurture flows. The marketer may then modify or customize the selected nurture flow according to the marketer's needs, such as modifying a number of segments in the nurture flow, defining an intended action for the nurture flow, defining one or more targeting parameters, or defining segment advancement criteria.

### Targeting Parameters

A segment in a nurture flow is associated with one or more targeting parameters that influence how one or more entities (e.g., targeted content system 170 and/or third party platform 180) interact with client device 110 used by a user associated with that segment. For example, a targeting parameter may be to provide a particular advertisement when a request for an advertisement is received from client device 110 in the associated segment. As another example, a targeting parameter may be to send an email message to an email account of the user, a text message to client device 110 (or another device operated by the user), or a message to an (e.g., “mobile”) application executing on client device 110 (or another device operated by the user). For purposes of brevity, although content may be targeted to other devices of a particular user, the following description involves sending content to client device 110.

A targeting parameter of a segment may indicate which entity is to perform an action associated with the segment. The entity may or may not be different than targeted content system 170. For example, in response to determining to target content to a user assigned to a segment, targeted content system 170 identifies a targeting parameter of the segment and, based on the targeting parameter, sends targeting instruction data to third party platform 180 (as opposed to another third party platform, not depicted). The targeting instruction data may identify client device 110 and include (or identify) particular content that third party platform 180 is to send to client device 110.

Examples of third party platform 180 that may be instructed to perform actions associated with a segment include social network providers (e.g., Facebook, LinkedIn, etc.), search engine providers, and ad providers. For example, a social network provider, based on targeting instruction data, may identify a user account and cause certain content to be displayed, to the user of the user account, in a news feed when the user is viewing web content (provided by the social network service) in a mobile application or in a web browser. As another example, an ad provider determines that a particular user is viewing a blog and causes an advertisement to be displayed on (or adjacent to) the blog. Such third party platforms are considered “channels” that are used to reach users that are assigned to segments in the nurture flow(s).

A targeting parameter may specify a particular channel to use to send content to a user. Additionally or alternatively, a targeting parameter may specify multiple channels and targeted content system 170 selects one of the channels based on one or more criteria, such as whether the user is reachable through the channel or has a history of being reached through the channel. For example, if it is known that a user has interacted with content delivered through channel A but there is no history of the user interacting with content delivered through channel B, then targeted content system 170 may select channel A over channel B. As another example, multiple channels may be ordered based on priority. If a user is not reachable through the top-most channel, then targeted content is sent to the user through the next highest ranked channel.

In an embodiment, the entity (e.g., a marketer) that initiates creation of a nurture flow selects targeting parameters when creating a nurture flow. Additionally or alternatively, other entities (e.g., an authorized user of targeted content system 170 or a user of viewer 160) may select targeting parameters of one or more segments.

In a related embodiment, a targeting parameter of a particular segment may be updated after a nurture flow is created and while users are current assigned to the particular segment. For example, a targeting parameter of a segment may specify that a first channel is to be used to delivery first content to users assigned to the segment. Later, the targeting parameter is updated to specify a second channel (that is different than the first channel) is to be used to deliver the first (or different) content to users assigned to the segment.

If a segment is associated with multiple targeting parameters, then targeted content system 170 may process each targeting parameter simultaneously or relatively close together in time. Additionally or alternatively, targeted content system 170 may process the multiple targeting parameters of a segment in a particular order over a pre-defined period of time, such as a different targeting parameter each day.

A targeting parameter may be associated with a repeating indicator that indicates a number of times the targeting parameter should be processed. For example, a targeting parameter with a repeating indicator of three will be processed at most three times relative to a user that is assigned to the corresponding segment, unless the user advances to another segment (or another nurture flow) before the targeting parameter is processed the third time.

In an embodiment, as soon as a user is assigned to a segment in a nurture flow, targeted content system 170 immediately processes one or more targeting parameters associated with the segment. Alternatively, a targeting parameter may be associated with a waiting time before which targeted content system 170 processes the targeting parameter. For example, after a user advances from the first segment to the second segment in a nurture flow, targeted content system 170 waits ten hours before processing any targeting parameter associated with the second segment.

In an embodiment, whether a targeting parameter of a segment is processed relative to a user depends on information about the user in a user record. For example, if the user is assigned to the segment and it is determined that the user is unemployed, then a first targeting parameter is processed; else, a second targeting parameter is processed. Thus, (e.g., augmented) user information in a user record may dictate, while a user is assigned to a particular segment, when the user is targeted, what content the user is targeted, and/or how or where the user is targeted.

### Segment Advancement Criteria

In an embodiment, nurture flow manager 220 uses one or more criteria to determine whether to assign a user (that is already assigned to a particular segment in a nurture flow) to another segment in the nurture flow. Such criteria are referred to herein as “segment advancement criteria.”

Segment advancement criteria may be conditions that, when satisfied, cause a user to be advanced to the next segment in a nurture flow. An example of such a condition is whether the user has performed a particular action, such as viewed a particular video, listened to a particular podcast, purchased a particular item, visited a particular web site, or physically visited a particular geographic location/region (such as a country). Evidence of performance of the particular action may come from (1) third party platform 180 (e.g., that detects the user, or client device 110, selecting an advertisement that third party platform 180 displays to the user), (2) client device 110 (that executes an application that detects the user selecting a particular link), (3) data augmenting system 150, or (4) another source, not depicted in FIG. 1.

In a related example, a segment advancement condition of a particular segment may be evidence that a user interacted with content that was targeted to the user based on a targeting parameter associated with the same segment. In other words, the condition that triggers the advancement of a user from a first segment to a second segment may be selecting an advertisement or viewing a video that is presented to the user according to a targeting parameter of the first segment.

Another example of a segment advancement condition is the user or a company/organization associated with the user being named or otherwise identified in a news article. The user may be a member/employee of the organization/employer (as indicated in a user record of the user) identified in the news article, may run/own the organization/company, or may be a board member/officer of the organization/company. Such social network data may come from data augmenting system 150, a social network service (not depicted in FIG. 1), or another source. Thus, an entity (e.g., data augmenting system 150 or an associated entity) may analyze news articles, alerts, and/or other content that is being published (e.g., even after the user is assigned to a segment in a nurture flow) and send that information to targeted content system 170 directly or through data augmenting system 150.

Another example of a segment advancement condition is the user having a new connection (in a social network) to another user that satisfies one or more criteria. For example, if company A is marketing to a particular user and the particular user becomes friends with an officer of company A (e.g., as indicated in an updated user record received by targeted content system 170), then the particular user advances to a subsequent segment in a nurture flow. Such social network data may come from data augmenting system 150 or another source (not depicted).

Thus, based on some of the foregoing examples, information from a user's online profile may be used to determine whether and/or when to advance the user from one segment to another.

Another example of a segment advancement condition is the user advancing to successive stages of a sales cycle, if user management system 140 keeps track of such advancement. For example, if success data (from user management system 140 or data augmenting system 150) indicates that (a) the likelihood of a user closing a deal (or the user performing a certain action) has increased a certain amount or past a particular threshold (e.g., 50%) or (b) a dollar amount associated with the deal has increased a certain amount or past a particular threshold, then the user may be reassigned to subsequent segment in a nurture flow.

Another example of a segment advancement condition is time. For example, a user that is in a current segment of nurture flow may advance to a subsequent segment of the nurture flow after the lapse of a particular amount of time, such as four days. In a related example, a current segment may have multiple segment advancement criteria, only one of which is time-based. Thus, if the user does not advance to the subsequent segment in the nurture flow based on one or more other segment advancement criteria, then, after the particular amount of time, the time-based criterion is triggered and the user is advanced to the subsequent segment.

### Segment Advancement Criteria: Measures of Influence

Additionally or alternatively, segment advancement criteria may be a measure of influence/engagement (also referred to as a “lead score”) or range of measures of influence. A measure of influence is indicative of how likely a user is to perform the intended action associated with a nurture flow, such as visiting a particular web page, downloading a video file, making a donation, or purchasing a product/service.

In this embodiment, a user is associated with a measure of influence and, if the user's measure of influence increases above the segment advancement criterion associated with the segment to which the user is currently assigned, then the user is advanced to another segment in the nurture flow. For example, one or more segments in a nurture flow may be associated with one or more lead scores (or a range of lead scores) that measure the relative probability of a user to perform the intended action of the nurture flow. If a user's lead score increases to be outside the range of the segment to which the user is currently assigned, then the user is assigned to the next (immediately adjacent) segment in the nurture flow or to another segment in the nurture flow, effectively “skipping” one or more intermediate segments.

Because a nurture flow includes multiple segments, each segment within the same nurture flow may be associated with different set of one or more segment advancement criteria and different types of segment advancement criteria.

Similarly, user interaction with one content delivery channel may cause a user to advance one segment in a nurture flow while subsequent user interaction with another content delivery channel may cause the user to advance to another segment in the same nurture flow. For example, a user may click on an advertisement presented to the user through channel A, which causes the user to advance from a first segment to a second segment in a nurture flow. Later, the user selects a link in a pop-up window provided through channel B, which causes the user to advance from the second segment to a third segment in the nurture flow.

### Example Components of Targeted Content System

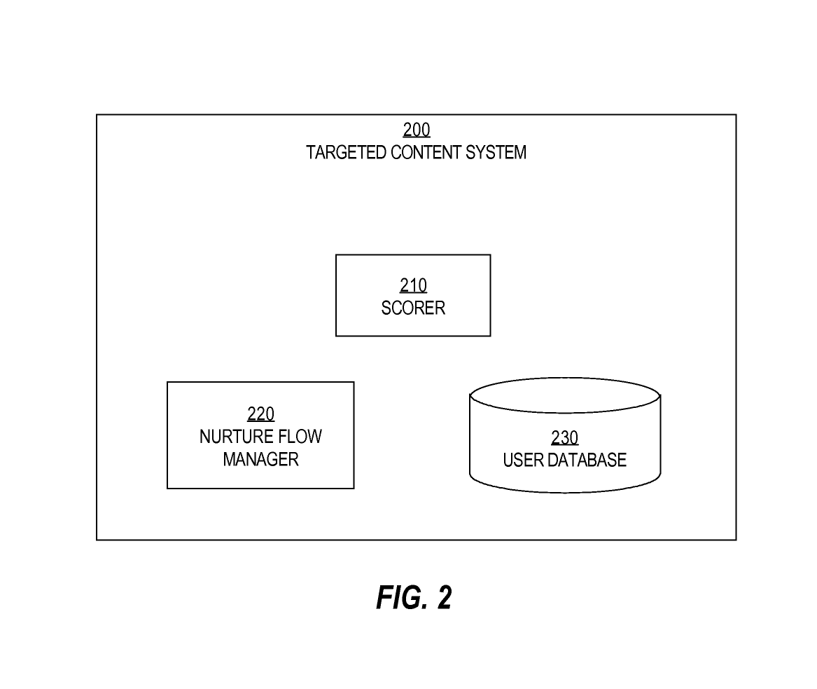

FIG. 2 is a block diagram that depicts multiple components of a targeted content system 200, which may be the same as targeted content system 170. Targeted content system 200 includes a scorer 210, a nurture flow manager 220, and a user database 230. Scorer 210 and a nurture flow manager 220 may be software application modules executing on targeted content system 200. Other embodiments of targeted content system 200 may include more or fewer components than 210-230.

In an embodiment, scorer 210 determines a measure of influence of a user based, at least in part, on the characteristics of the user (or the user's connections), what actions the user has performed, and/or other criteria being satisfied. For example, scorer 210 may be responsible for analyzing augmented data from data augmenting system 150. Additionally, scorer 210 updates the measure of influence (e.g., a lead score) for a user using information received from data augmenting system 150, a marketer (not depicted), third party platform 180, or some combination thereof.

Nurture flow manager 220 is configured to map (or assign) users (or their respective client devices) to certain nurture flows and, additionally, to specific segments within the nurture flows. Nurture flow manager 220 may take into account measures of influence (or lead scores) determined by scorer 210. Nurture flow manager 220 may assign a user to the first segment in a nurture flow when the user is first associated with the nurture flow. Additionally or alternatively, nurture flow manager 220 may assign a user to some other segment in a nurture flow based on information received from data augmenting system 150 or some other source, such as third party platform 180, or a marketer (not depicted).

User database 230 stores user records (whether augmented by data augmenting system 150 or from user management system 140). Embodiments are not limited to how user database 230 is implemented. Examples of user database 230 include a relational database, an object database, an object-relational database, a NoSQL database, or a file system. For example, each user record may be stored as a row in a table, where each table corresponds to a different nurture flow or a different entity that initiated creation of the nurture flow.

### Example Nurture Flows

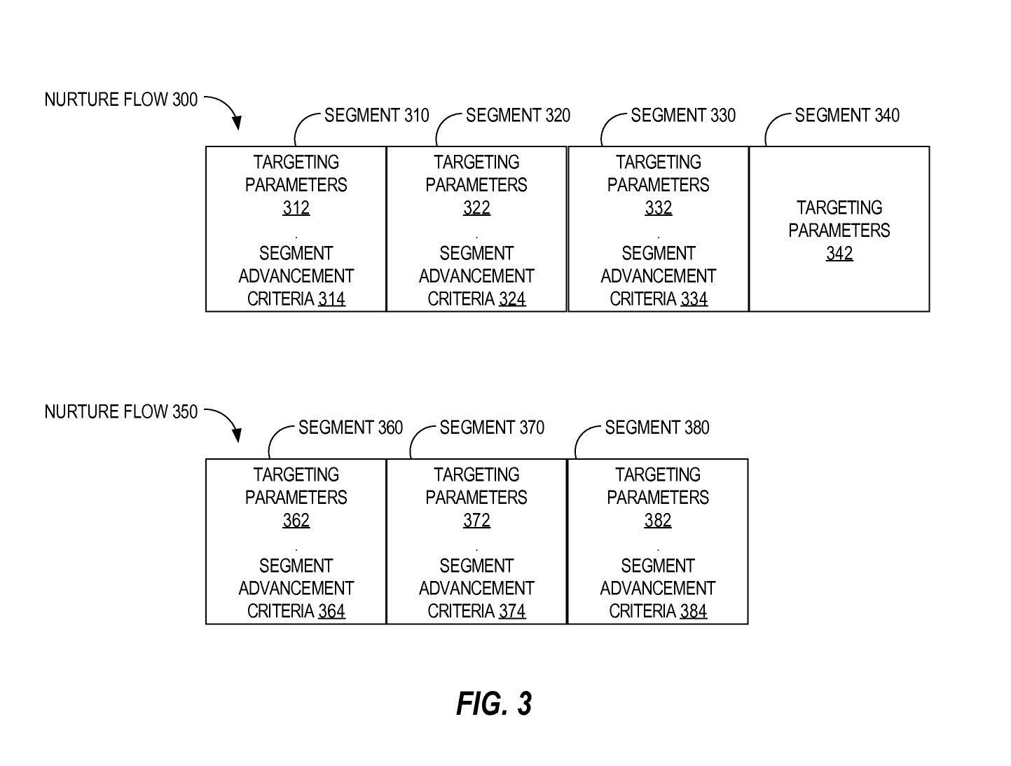

FIG. 3 is a block diagram that depicts example nurture flows 300 and 350, in an embodiment. As described previously, nurture flows 300 and 350 may be created based on user input that nurture flow manager 220 processes or may be created automatically. Also, nurture flows 300 and 350 may be created for the same entity or for different entities.

In the depicted example, nurture flow 300 includes four segments 310-340 while nurture flow 350 includes three segments 360-380. Segment 310 includes (or is associated with) targeting parameters 312 and segment advancement criteria 314; segment 320 includes targeting parameters 322 and segment advancement criteria 324; and so forth. However, segment 340 does not include segment advancement criteria. This may be the case if the user is not able to advance any further. Either the user performs an intended action associated with nurture flow 300 or not.

In contrast, the last segment in nurture flow 350 includes segment advancement criteria 384. Such criteria may indicate that a user that is assigned to segment 380 may be assigned to another nurture flow if, for example, the user did not perform an intended action associated with nurture flow 350. Thus, the user may continue to be nurtured, but perhaps in a different way and intensity, as reflected by the targeting parameters and segment advancement criteria of the other nurture flow.

While a user is assigned to segment 310, nurture flow manager 220 processes targeting parameters 312 to determine what content will be delivered to the user, how the content will be delivered (such as which delivery channel to use), and, optionally, when the content will be delivered. Nurture flow manager 220 also processes segment advancement criteria 314 to determine whether to advance the user to segment 320 (or to another segment in nurture flow 300).

Nurture flow manager 220 similarly processes targeting parameters 362 for users that are assigned to segment 360 of nurture flow 350 and processes segment advancement criteria 364 to determine whether to advance the user to segment 370 or segment 380 in nurture flow 350.

### Opt-in/Out Option

As described previously, a user record in data augmenting system 150 or user management system 140 may be automatically transferred to targeted content system 170, for example, when the user record is initially created or when the user record is updated.

In an embodiment, a user record is only sent to targeted content system 170 if the user record is associated with opt-in data. Opt-in data indicates that a set of one or more user records may be sent to targeted content system 170. If a user record is not associated with opt-in data, then the user record is not sent to targeted content system 170.

In an alternative embodiment, a user record is automatically sent to targeted content system 170 if the user record is not associated with opt-out data. If a user record is associated with opt-out data, then the user record cannot be sent to targeted content system 170.

User input may be provided that associates opt-in/out data with a set of one or more users. The user input may come from a user operating viewer 160 or another user interacting with data augmenting system 150 or user management system 140. Opt-in/out data may be specified on a per user record basis (where a user selects the individual user records or specifies names of individuals) or on a group basis. For example, in order for a set of multiple user records to be sent to targeted content system 170, the set of user records must be associated with opt-in data. As another example, a user of viewer 160 (or another device) lists names and/or email addresses of users to which content should be automatically targeted. As another example, a user of viewer 160 specifies criteria that a user must satisfy in order for the user to receive automatically targeted content. For example, the criteria may be users with a certain seniority level in a company and/or with a certain job title.

In the foregoing examples, opt-in/out data is stored in user management system 140 or data augmenting system 150 and applied by system 140 or 150. Alternatively, targeted content system 170 stores and applies opt-in/out data to user records received from system 140 or 150. In either embodiment, a user (e.g., someone representing a marketer) defines the set of user that should be automatically targeted with certain content.

### Bouncer Nurture Flows

In an embodiment, targeted content system 170 (or another system) maintains “bouncer nurture flows.” A bouncer nurture flow is designed for users (known or unknown) that did not perform a particular action (or set of actions) that would have caused a user record to be created in user management system 140. Such users are referred to herein as “bouncers.” For example, a bouncer may have clicked on an advertisement, which caused a form on a web page to be displayed, but did not fill out the form by inputting personal information. A bouncer initially showed interest in a product or service or in performing a particular action, but, for whatever reason, decided to not pursue learning about the product/service any further. Content may be targeted to bouncers, similar to “non-bouncers.” However, different content, delivery channels, and/or timing may be used when targeting bouncers. Such different content, delivery channels, and/or timing of the different content are reflected in one or more bouncer nurture flows that are separate from nurture flows that are designed for non-bouncers. Similar to “regular” nurture flows, a bouncer nurture flow may be managed by nurture flow manager 220.

Which bouncer nurture flow a bouncer is assigned (and/or which segment the bouncer is to be assigned) may depend on how much information is known about the bouncer and what is known about the bouncer. For example, one bouncer nurture flow may be created for bouncers for which very little are known, other than, for example, an email address. In that case, until the email address is associated with a client device or a user identifier, email is the only channel through which content may be targeted. A second bouncer nurture flow may be created for bouncers that satisfy one set of nurture flow assignment criteria (e.g., board members of a pharmaceutical company) and a third bouncer nurture flow may be created for bouncers that satisfy another set of nurture flow assignment criteria (e.g., founders of a software company).

For example, web server system 130 may only have a device identifier that identifies client device 110 (operated by the bouncer). However, the device identifier may be mapped to a user identifier, which may identify (or map to another identifier that identifies) one or more user accounts maintained by one or more social network providers. By mapping to the user account, personal information about the bouncer may be determined, such as age, gender, residence, job history, job title, employment status, academic history, personal interests, and organizations to which the bouncer belongs.

### Example Process

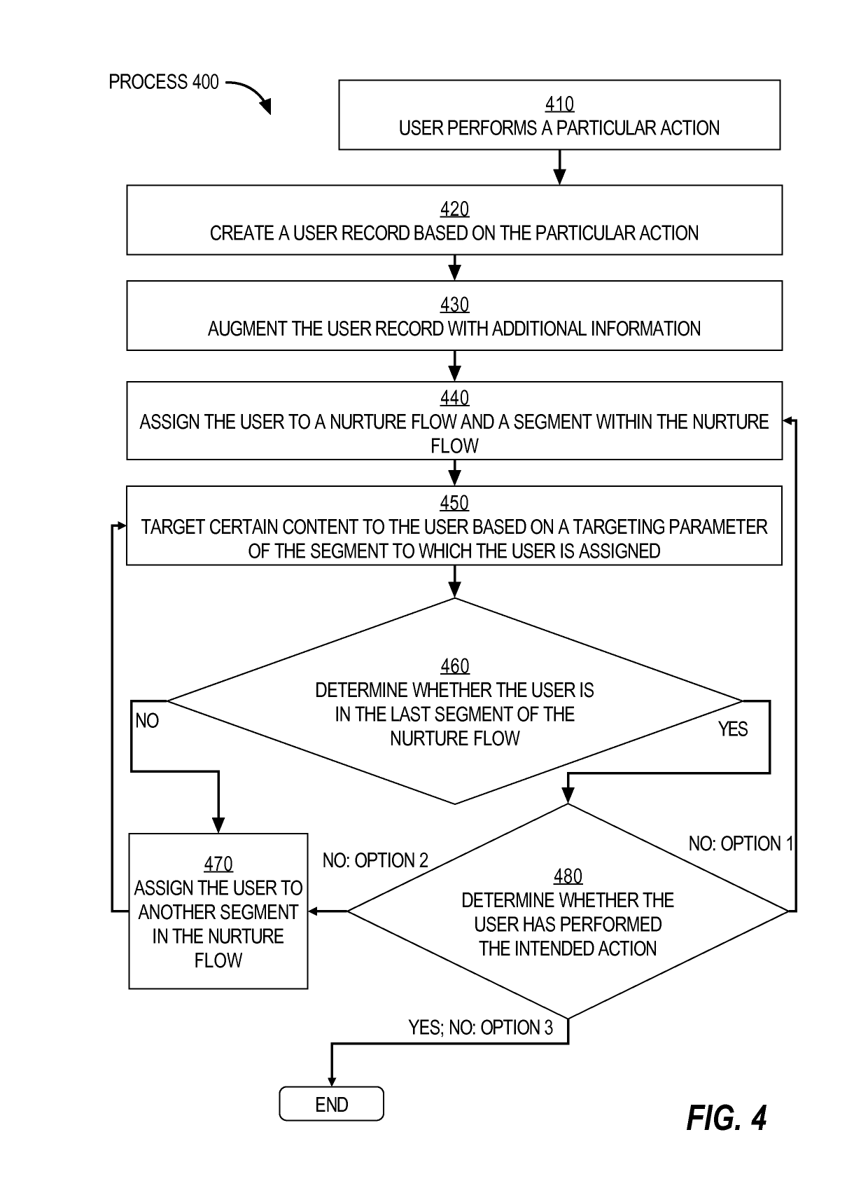

FIG. 4 is a flow diagram that depicts an example process 400 for automatically targeting content to a user, in an embodiment. Process 400 may be implemented across multiple elements in FIG. 1.

At block 410, a user performs a particular action. Examples of the particular action including filling out a form on a particular web site (e.g., hosted by web server system 130), visiting a particular web page, viewing an advertisement, clicking on an advertisement, attending a trade show or a networking event, joining a particular company, changing roles within the same company, or receiving public recognition for whatever reason, such as a certain achievement.

At block 420, a user record is created based on the particular action. Block 420 may involve user management system 140 receiving user data from web server system 130 (or another source) and creating the user record to be stored in a CRM system.

At block 430, the user record is augmented with additional information. Block 430 may involve data augmenting system 150 receives the user record from user management system 140 and modifying the user record with the additional information. The additional information may be from a social network provider that maintains information about the user. For example, the social network provider may be a professional social network provider that maintains educational and job history information about the user and other users with which the user is connected in a social network.

At block 440, the user is assigned to a nurture flow. Block 440 may involve targeted content system 170 receiving the augmented user data from data augmenting system 150 and selecting a nurture flow (if more than one exists) to which the user is to be assigned. The nurture flow may be selected from among a plurality of possible nurture flows and/or based on comparing user data with nurture flow assignment criteria associated with each of multiple nurture flows. Initially, the user may be assigned to the first segment in the nurture flow.

At block 450, certain content is targeted to the user based on the targeting parameter(s) of the segment to which the user is assigned. Block 450 may involve nurture flow manager 220 identifying particular content and a channel through which the particular content will be delivered to the user. Nurture flow manager 220 sends the particular content and a device or user identifier “onto” the channel (or to, for example, third party platform 180), which is responsible for presenting the particular content to the user.

At block 460, it is determined whether the user is in the last segment in the nurture flow. If not, then process 400 proceeds to block 470. Else, process 400 proceeds to block 480.

At block 470, it is determined that the user satisfies one or more segment advancement criteria and assigns the user to a subsequent segment in the nurture flow. Block 470 may be performed by nurture flow manager 220. Process 400 proceeds to block 450.

At block 480, it is determined whether the user performed the intended action (e.g., purchased a particular product) associated with the nurture flow. If so, then process 400 ends. Else, process 400 may proceed to block 440 where the user is assigned to another nurture flow, which may be designed for users that did not perform the intended action. Alternatively, process 400 may proceed to block 470 where the user is assigned to another (i.e., previous) segment in the nurture flow. Additionally or alternatively, process 400 may end after two or more iterations of block 480 for the particular user.

Although process 400 is depicted and described as being performed in a particular order, process 400 may be performed in a different order. For example, the determination of whether a user has performed the intended action associated with a nurture flow (block 480) may be performed before determining whether the user is assigned to the last segment in a nurture flow (block 460).

### Benefits of Various Techniques

Techniques described above for automatically targeting content to certain users may provide one or more benefits. One benefit may be that users who have exhibited an interest in a product/service or performing a particular action (e.g., by visiting a particular web page or filling out a form) can be automatically targeted (or “nurtured”) in a systematic way. Another benefit may be that content can be automatically targeted to a user through multiple channels to encourage the user to perform the intended action. Another benefit may be that information about a particular interested user can be augmented based on the user's profile in a social network and the augmented information is used to better target the user. Another benefit may be that content can be targeted to a user's device that is different than the device the user used when initially exhibiting his/her interest in the product/service.

Another benefit may be that, with respect to at least one user, a sales approach (e.g., using user management system 140) and a marketing approach (using targeted content system 170) are coordinated. For example, as soon as a record for a company executive is created in a CRM database, content is automatically targeted to the company executive to “nurture” the company executive towards performing an intended action. As another example, as a user advances to successive stages in a sales process (e.g., through manual efforts of a sales representative), such input is provided to targeted content system 170. In response, targeted content system 170 assigns the user to subsequent stages in a nurture flow or to an entirely different nurture flow, resulting in increasing the intensity (e.g., in frequency and/or in type of content) with which content is targeted to the user.

### Collecting Additional User Data

In an embodiment, information about the activity of targeted users is collected. The information may be collected by one or more third party platforms (e.g., third party platform 180), targeted content system 170, data augmenting system 150, user management system 140, or a combination thereof. The activity of targeted users may pertain to what actions the users performed while the users were assigned to certain nurture flows or certain segments. For example, in response to receiving targeting instruction data from targeted content system 170, third party platform 180 causes a particular link to a video (or advertisement) to be displayed to a user (e.g., through client device 110). Third party platform 180 determines that the user selects the particular link and sends, to targeted content system 170, a message reporting about the selection, such as an identity of the user (and/or client device 110), what content was selected, when the selection occurred (e.g., time of day, day of week, month, year), what browser or application the user used to perform the selection, and/or where the user (or client device 110) was located (e.g., geographically) at the time of the selection. Targeted content system 170 associates the data in the message with the user and/or with the nurture flow and segment responsible for the targeting instruction data.

As another example, a sales representative updates a user record in user management system 140 to indicate that the corresponding user performed a certain action or that something of significance happened to the user. Such an action may be agreeing to a lunch meeting with the sales representative (or another member of a company), visiting a particular warehouse owned by the company, attending a trade show, attending an online seminar, completed a telephone call, etc.

Other information that may be collected about a targeted user may include relevant events that occurred in a social network in which the target user is a member or events that are reported in social media or elsewhere on the World Wide Web. For example, immediately prior to a targeted user being assigned to a nurture flow, the targeted user changed employers, changed roles within her company, or increased the number of connections in an online social network to which s/he belongs by twenty connections or 10%.

Information that is collected about a targeted user may include timing and/or sequence information. For example, a user changed jobs at time 1, filled out a form on a web page at time 2, was presented targeted content (according to a nurture flow) on channel Z at time 3, increases the number of his connections by over 10% between time 3 and time 4 (which is less than three days), and performed an intended action (associated with the nurture flow) at time 5. The timing and sequence of events that led to the user performing the intended action may be used, in conjunction with similar data regarding other targeted users who performed their respective intended actions, to predict (as described in more detail below) what other users should be targeted, even users who are not currently represented in data augmenting system 150 (as described in more detail below).

### Nurture Flow Reports

In an embodiment, information about users' progress through nurture flows is tracked. A nurture flow may be associated with a success rate, which indicates a number (or percentage) of users that were assigned to the nurture flow and also performed the intended action. For example, an entity (or representative thereof) creates three nurture flows with the same intended action. Targeted content system 170 determines that 50% of users assigned to Nurture Flow A perform the intended action, 25% of users assigned to Nurture Flow B perform the intended action, and 5% of users assigned to Nurture Flow C perform the intended action. Targeted content system 150 may generate a report that indicates the success rate of each nurture flow, which allows entities (e.g., marketing individuals that established the nurture flows) to determine which nurture flows are most effective.

As another example, targeted content system 170 tracks how many users assigned to a nurture flow progress to subsequent segments in the nurture flow. For example, 80% of users in the first segment of a nurture flow advance to the second segment in the nurture flow, while only 30% of users assigned to the second segment advance to the third segment in the nurture flow, while 50% of users assigned to the third segment advance to the fourth segment in the nurture flow. Thus, the first segment has an “advancement rate” of 80%, the second segment has an advancement rate of 30%, and the third segment has an advancement rate of 50%.

In addition to a nurture flow's success rate and a segment's advancement rate, a report may indicate one or more of the following pieces of information: an indication of which delivery channels were used in each segment, an average or median amount of time users were assigned to a nurture flow, an average or median amount of time users were assigned to a particular segment, a segment's advancement rate when a particular delivery channel was used (e.g., relative to when another delivery channel was used for that same segment), a (e.g., percent) change in a segment's advancement rate before and after a change in a targeting parameter (e.g., a different delivery channel was used), a (e.g., percent) change in a segment's advancement rate before and after a change in segment advancement criteria, a (e.g., percent) change in a segment's advancement rate before and after a change in timing of when a targeting parameter is processed.

A report may also indicate characteristics or attributes of users that (1) performed an intended action of a nurture flow, (2) did not perform the intended, (3) advanced from a particular segment, and/or (4) did not advance from a particular stage. For example, 80% of users that made a donation to a particular charity had an advanced degree. As another example, 95% of users that did not advance from a first segment to a second segment in a nurture flow have graduated from college in the last three years.

In an embodiment, target content system 170 automatically generates one or more reports regarding a nurture flow. A report may be generated when certain criteria (referred to as “report generation criteria”) are satisfied, such as a nurture flow's success rate being under 5% for two consecutive days or the advancement rate of a segment dipping below 20% after one week of the nurture flows creation. “Report generation criteria” for a nurture flow may be default criteria (i.e., established by targeted content system 170) or may be provided (or at least selected) by the entity (e.g., marketer) that initiated creation of the corresponding nurture flow.

Based on report information, an entity may instruct targeted content system 170 to delete one or more (e.g., “poor” performing) nurture flows, modify an existing nurture flow (such as changing a channel associated with a segment or changing a segment advancement criterion of a particular segment), or add one or more new nurture flows.

In an embodiment, an entity creates a set of nurture flows that differ significantly from each other and instructs targeted content system 170 (or data augmenting system 150) to randomly assign users to one of the nurture flows in the set. In this way, the entity may determine which nurture flow in the set is performing the best. This is a form of A/B testing. The entity (and/or data augmenting system 150) may then delete the poorer performing nurture flows and create additional nurture flows that differ less significantly from the best nurture flow. This process may repeat any number of times. In this way, the entity may come to identify a nurture flow that performs better than, not only the initial “best” nurture flow, but also other nurture flows that were considered “best” in rounds subsequent to the initial round.

### Nurture Flow Change Recommendations

In an embodiment, targeted content system 170 recommends one or more changes to make to a nurture flow or set of nurture flows established by a particular entity. The recommendations may accompany a nurture flow report and may be based on information tracked for the nurture flow. For example, targeted content system 170 recommends that segment advancement criteria of a particular segment be relaxed due to a low advancement rate associated with the particular segment. As another example, targeted content system 170 recommends that the amount of time that elapses before a targeting parameter of a particular segment is processed should be increased by one day.

A recommendation may also be based on information collected regarding one or more other nurture flows, even nurture flows that were established by other entities (e.g., marketers). For example, targeted content system 170 recommends that a delivery channel be used for a particular segment based on that delivery channel's success with respect to other nurture flows.

### Automatically Modifying Nurture Flows

In an embodiment, targeted content system 170 is configured to automatically delete or modify a nurture flow. For example, if less than 5% of users assigned to a particular nurture flow are performing the intended action while assigned to the particular nurture flow (e.g., within a particular period of time), then the particular nurture flow is deleted. The deletion may be predicated on there being one or more other nurture flows (established for the same entity as the deleted nurture flow) to which future users may be assigned.

As another example, targeted content system 170 determines that third party platform 180 (or another delivery channel) indicated in a particular segment of a nurture flow is offline or otherwise not responsive. In response, targeted content system 170 selects a different third party platform or delivery channel for the particular segment. As another example, targeted content system 170 determines that less than 15% of users assigned to a particular segment in a nurture flow are advancing to a subsequent segment in the nurture flow. In response, targeted content system 170 (a) notifies the “owner” or establisher of the nurture flow and, optionally, suggests a modification to the nurture flow or (b) relaxes the segment advancement criteria associated with the particular segment such that it is easier for users to advance to subsequent segments in the nurture flow.

### Automatically Creating a Nurture Flow

In an embodiment, targeted content system 170 is configured to create a new nurture flow. A new nurture flow may be created automatically based on one or more factors, such as user behavior across one or more existing nurture flows, user behavior detected on other computing platforms (e.g., third party platform 180), response rates (e.g., ratio of users who responded to an email by clicking on a link within the email), conversion rates (e.g., ratio of users who performed the intended action(s) of one or more nurture flows), etc.

A new nurture flow for a particular entity may be based on one or more other nurture flows established by or for the particular entity. For example, an entity creates two nurture flows that are similar except for the second and fourth segments. Targeted content system 170 determines that a first nurture flow is advancing users from the second segment at a higher rate than the second nurture flow, but that the second nurture flow is advancing users from the fourth segment at a higher rate than the first nurture flow. In response, targeted content system 170 creates a third nurture flow that is identical to the first nurture flow, except that the fourth segment in the third nurture flow uses the targeting parameters of the fourth segment in the second nurture flow.

As another example, delivery channels associated with the highest user interaction (e.g., in terms of views, clicks, or other type of interaction) are identified and used to create a new nurture flow that uses only those delivery channels.

As another example, nurture flows associated with the highest conversion rates are identified and attributes of those nurture flows are combined to create a new nurture flow. As a specific example, it is determined that a relatively high percentage of users who are targeted a first type of content (e.g., video) through a first third-party platform advance to subsequent segments in one or more nurture flows. It is also determined that a relatively high percentage of users who are targeted a second type of content (e.g., images and text only) through a second third-party platform advance to subsequent segments in one or more other nurture flows (which may have been created or initiated by an entity that is different than the entity that created/initiated the first nurture flow(s)). Then, a new nurture flow is created based on attributes of both sets of nurture flows. In this example, a further check may be performed to ensure that the type of intended action and/or the type of service/product associated with the new nurture flow is the same or similar to the types of intended actions and/or types of service/products associated with both sets of nurture flows. Thus, a new nurture flow may be created from existing nurture flows only if certain conditions are met.

A new nurture flow may be initially “inactive.” An “active” nurture flow is one to which users may be assigned. Conversely, an “inactive” nurture flow is one to which users may not be assigned without explicit input. For example, a new nurture flow is initially inactive and the entity that is associated with the nurture flow (or representative thereof) is notified of the new nurture flow. A notification may come through any notification channel, such as an email message, an IM, an automated telephone call, or a display message when a representative of the entity logs into targeted content system 170 to manage the entity's nurture flow(s). The entity representative must then provide explicit input (e.g., checking a box, or selecting a URL in a body of an email) to activate the new nurture flow.

### Predicting Future Targeted Users

In an embodiment, the collected information is used to identify users who are not known to have exhibited any interest in a particular product/service or in performing a particular action, such as making a donation or purchasing a particular product. Such users are referred to herein as “potential prospects.” Thus, a potential prospect may not yet be someone who is represented in a user record of a CRM database. However, a potential prospect may be similarly targeted using targeted content system 170.

In a related embodiment, a potential prospect is an individual with an account in a social network, an individual represented or identified in a CRM database, an individual that matches (e.g., demographic) criteria specified in a marketing system, and/or an individual that has purchased (e.g., as indicated in a purchase database) one or more products or services that are similar to a product or service associated with a candidate nurture flow. Thus, a potential prospect may have exhibited some interest in making a purchase or exhibited some interest in the subject matter of the intended action of a nurture flow. Such sources of potential prospects may be best to leverage initially rather than targeting “random” people, in a social network, who happen to share characteristics with users who have performed intended action(s) of one or more nurture flows.

As described previously, data augmenting system 150 and targeted content system 170 may be implemented on the same platform or at least be owned/operated by the same entity. Thus, targeted content system 170 may have access to the same data that data augmenting system 150 does when augmenting user data from user management system 140. For example, targeted content system 170 has access to profile data of users in one or more online social networks, such as LinkedIn, Facebook, or Google+.

### Comparing User Profiles

In an embodiment, profiles of users who performed an intended action associated with a nurture flow (referred to herein as “successful users”) are compared to user profiles in a social network to identify one or more matching profiles in the social network. A “matching” profile is not necessarily an exact match. For example, two profiles may match even though the corresponding users reside in very geographically different locales.

A user profile (whether of a targeted user or of a potential prospect) includes information about the user, such as gender, age, ethnicity, income level, country/state/city of residence, current and previous employers, current and previous job titles, current and previous industries, academic institutions attended, job status, organizations in which the user is a member, skills, number and identity of connections, recommendations from connections, sports interests, entertainment interests, and/or hobbies.

A user profile may also include event information, such as the user (or the user's employer) being mentioned in a news article or blog. Event information for a particular event may indicate when the particular event occurred. Such timing information may be used when identifying a matching profile. For example, if 80% of successful users of a nurture flow updated their user profiles in one or more social networks within five days of being assigned to the nurture flow, then the fact that a potential prospect updated his/her user profile in an online social network makes the potential prospect a more likely candidate for assigning to the nurture flow.

In an embodiment, the profile of a successful user is used to compare against other user profiles to determine whether any of the other user profiles match the profile of the successful user. In this way, the profile of that one successful user is used to predict which potential prospects are most likely to perform an intended action of a nurture flow and, therefore, should be targeted.

The profile of the successful user may be selected in any fashion, such as selecting the first successful user of a nurture flow, selecting the most recent successful user of the nurture flow, selecting the “fastest” successful user (i.e., one that performed an intended action of the nurture flow in the shortest time from when the user was assigned to the nurture flow), or randomly.

In an embodiment, profiles of some successful users are eliminated from consideration based on one or more criteria. For example, 95% of successful users may have a particular job title but only 3% of all users that (1) have the particular job title and (2) were assigned to the corresponding nurture flow performed the intended action. Therefore, the particular job title may not be determinative of success. As another example, 5% of successful users may have be in a particular industry, but 85% of all users that (1) are in the particular industry and (2) were assigned to the corresponding nurture flow performed the intended action. In this example, a user's industry is determinative of success.

A ratio of (a) successful users with a particular attribute value to (b) all users that have the particular attribute value and that have been assigned to the corresponding nurture flow may be determined. This ratio is referred to herein as a “determinative ratio.” An attribute value associated with a relatively high determinative ratio may be a factor in selecting matching profiles. For example, if the determinative ratio associated with the particular attribute value is above a certain threshold (e.g., 50%), then potential prospects that are associated with the particular attribute value (and zero of more other “highly” determinative attribute values) are identified.

### Creating a General Profile

In a related embodiment, a general profile of successful users who successfully performed the intended action of a nurture flow is generated. The general profile is then compared to profiles of potential prospects to determine whether any of the profiles match the general profile. Thus, a general profile represents multiple successful users and is used to predict which potential prospects are most likely to perform an intended action of a nurture flow.

In an embodiment, for each of one or more attributes in a general profile, the general profile includes all (or a subset of) attributes values of the successful users associated with the general profile. For example, a general profile may include a job title attribute that lists the job titles of all (or a subset of) the successful users. As another example, a general profile may include a connection attribute that indicates a range of a number of connections (e.g., between ninety-two and three hundred) that successful users have in one or more social networks.

Additionally or alternatively, for each of one or more attributes in a general profile, the general profile includes a single attribute value, such as a minimum threshold of connections, a single job title, and the most recent prior employer. Thus, attribute values of some successful users may be excluded from the general profile. In this embodiment, the most common value of a particular attribute may be selected for inclusion in the general profile. For example, if 40% of successful users have a first job title, 35% of successful users have a second job title, and 25% of successful users have a third job title, then the first job title is selected for inclusion in the general profile. Alternatively, the determinative ratio of various attribute values may be used to determine which attribute value to include in a general profile.

In an embodiment, a general profile is generated based on successful users from multiple nurture flows. For example, if a marketer initiated the creation of three nurture flows, then a general profile may be created based on all (or a subset of) successful users from all three nurture flows. In a related embodiment, a general profile is only created based on successful users of nurture flows that are associated with the same intended action (or same type of intended action). Thus, in the most recent example, if only two of the three nurture flows are associated with the same intended action, then only profile data of the successful users from those two nurture flows are used to generate a general profile.

Regardless of how a general profile is created, the general profile may be associated with the nurture flow through which the successful users passed. Additionally or alternatively, a general profile is associated with the entity that established the corresponding nurture flow(s).

In a related embodiment, a general profile is created based on the same or similar intended actions or the same or similar products/services that are the subject of the intended actions. Thus, not only might the successful users of the general profile may be associated with different nurture flows, the successful users may be associated with different nurture flows from different entities (e.g., marketers). For example, two nurture flows are created by different marketers that are marketing computer storage systems, only one of which is a cloud-based solution. Targeted content system 170 may generate a general profile that is based on successful users from both nurture flows. As another example, two nurture flows are created by different charitable organizations that are seeking donations for helping children with physical or mental disabilities. Targeted content system 170 may generate a general profile that is based on successful users from both nurture flows.

### Weighted Profile Attributes

In an embodiment, when performing a comparison between two profiles, some profile attributes may be considered while other profile attributes may be ignored, such as residence information, hobbies, gender, or number of connections. In a related embodiment, some profile attributes may have a higher weighting than other attributes, such as job title, work industry, undergraduate degree, graduate institution, number of connections in a particular industry, place of residence, gender, second language, skills, current employer, previous employer, and employment status.

A weight for an attribute (or attribute value) may be manually specified by, for example, the entity that established a nurture flow or a representative of target content system 170. Alternatively, a weight for an attribute (or attribute value) may be based on attribute values of successful users or a determinative ratio for an attribute value. For example, for a particular nurture flow, a determinative ratio for a first job title is below a threshold while a determinative ratio for a second job title is above the threshold. Thus, users having the first job title may not be weighted as high as users having the second job title.

After attribute values of two profiles are compared, a similarity score is generated to reflect how similar the two user profiles are. If different attributes are associated with different weights or priorities, then a match of a higher priority attribute will have a greater effect on the similarity score than a match of a lower priority attribute.

### Identifying Prospects

A potential prospect whose profile has a similarity score above a certain threshold is considered a prospect. Because a user's profile may be compared to multiple general profiles, the user may be a prospect for some entities (e.g., marketers) but not for other entities.

The threshold similarity score above which a user is considered a prospect may vary from entity to entity or even from nurture flow to nurture flow. For example, one marketer may set a threshold similarity score to 0.95 (on a scale from ‘0’ to ‘1’, ‘1’ being an exact match) and another marketer may set a threshold similarity value to 0.82.

As another example, a marketer may set a threshold similarity score to 0.9 for a first nurture flow and 0.8 for a second nurture flow. In this example, if a potential prospect matches a profile (whether general or specific) for the first nurture flow, then the potential prospect is associated with the first nurture flow. Similarly, if a potential prospect matches a profile (whether general or specific) for the second nurture flow, then the potential prospect is associated with the second nurture flow.

In an embodiment, a prospect is immediately assigned to a nurture flow. Alternatively, information about one or more prospects is displayed to an entity associated with the prospect(s). For example, a marketer may log into data augmenting system 150 and request information about prospects for a particular nurture flow. In response, data augmenting system 150 displays a list of names. To keep the names confidential, profile identifiers may be displayed in place of first and/or last names. The list may be ordered based on any criteria, such as similarity scores, such that prospects associated with high similarity scores are listed higher than prospects associated with lower similarity scores. The marketer may select individual names (or profile IDs) to view profile information about the selected prospect. The marketer may provide input that selects one or more prospects from the list for current content targeting.

### Model Approach

The techniques described previously regarding identifying prospects through comparing profiles of successful users (or a composite profile representing multiple successful users) with profiles of potential prospects is one approach for identifying prospects. Additionally or alternatively, prospects are identified using a predictive modeling approach.

Thus, in an embodiment, a model is created, trained, and is used to identify prospects (or rank currently-targeted users). Attributes associated with a user are inputs to the model, which outputs a score that is used to determine whether to consider the user as a prospect and, thus, add the user to a nurture flow. In modeling parlance, the attributes that are used to train a model and are input to the trained model are referred to as “feature values,” which correspond to “features” that the model is configured to track.

Supervised learning is a type of machine learning task that involves inferring a function from labeled training data. One type of supervised learning involves classification (where the output is a category, such as “successful” or “unsuccessful”) and another type of supervised learning involves regression (where the output is a continuous value, such as between 0 and 1). Embodiments are not limited to the type of machine learning that is used to create and train the model.

In one approach, a model is trained using labeled data. For example, some labeled data may be of successful users and other labeled data may be of unsuccessful users. Thus, the model is trained to learn the features that are determinative of successful users and the features that are not.

Examples of types of features that may be used to train the model include user profile data and online user behavior. Examples of user profile data items include current and past job titles, current and past employers, academic degrees achieved, education institutions attended, current employment status, types and number of skills, types and number of endorsements, places lived, hobbies, personal interests, number of friends or connections in a social network, number of connections the user has in a social network, and number of connections with a certain class or group of users (e.g., executives, lawyers, or IT professionals).

Examples of online user behavior include number of connections made within the last week, number of posts by the user, number of comments by the user regarding content items provided by other user, number of “likes” by the user of content items provided by other users, types and number of web pages and/or web sites that the user visited, number of logins of the user to a website (e.g., a social networking website), number of content subscriptions, number and type of companies the user follows, number of individuals the user follows, number of online job searches the user has initiated, type of online searches the user has initiated, number of invitations the user sent to others to connect in a social network, number of invitations the user received from others to connect in a social network, number of invitations the user sent to others that were declined, number of invitations received that the user declined, and an online reputation score of the user. Some of the above-referenced numbers or frequencies may be totals over the “lifetime” of the user or over a certain period of time, such as the last week or month.

### Multiple Models

In an embodiment, multiple models are created and trained. A different model may be created and trained for each nurture flow. Thus, if multiple nurture flows are established by or for a single marketer, then a model is created and trained for each of the marketer's nurture flows. Alternatively, a different model is created and trained for each marketer, but a single model may be used to identify multiple prospects (or rank identified prospects) for multiple nurture flows established by or for a single marketer. Alternatively, a single model is created and trained for multiple nurture flows established by or for multiple marketers.

### Training Data

A model may be trained using different types of users (“successful” or “unsuccessful”), labeled as such. In one approach, all known (or at least labeled) successful users and unsuccessful users are used to train a model. In another approach, a subset of all successful users and a subset of all unsuccessful users are used to train a model.

If there are multiple models, then the models are trained based on successful and unsuccessful users from the corresponding nurture flows. For example, if a model is created and trained for nurture flow A, then successful and unsuccessful users associated with nurture flow A are used to train the model. As another example, if a model is created and trained for nurture flows that are similar to nurture flows B and C (but that may not yet be created), then successful and unsuccessful users associated with nurture flows B and C are used to train the model.

Some unsuccessful users may have been users assigned to multiple nurture flows. If, for example, multiple instances of an unsuccessful user are used to train a model (because the unsuccessful user was assigned to multiple nurture flows), then the model may be trained “too much” for that one unsuccessful user and, as a result, the model may not detect other users as potential unsuccessful users.

### Validation

In an embodiment, a model is validated by selecting a number of data sets (or sets of successful and/or unsuccessful users) and applying them as input to the model. Each data set is also labeled, such as successful users or unsuccessful users. The model generates a score that indicates whether a user is likely to be a successful user or unsuccessful user and that result is compared to the correct answer. If the model is correct a certain percentage of the time (e.g., 99%), then the model is deemed validated and ready for use in production to identify prospects from among a set of users.

If the model is not correct a threshold percentage of the time, then the model is not ready for production. One of multiple approaches may be used at this point. In one approach, a new model is created and trained on a different set of training data, such as randomly-selected known successful users and/or known unsuccessful users. In another approach, the non-validated model is trained based on additional users who are considered similar to the users that the model incorrectly scored.

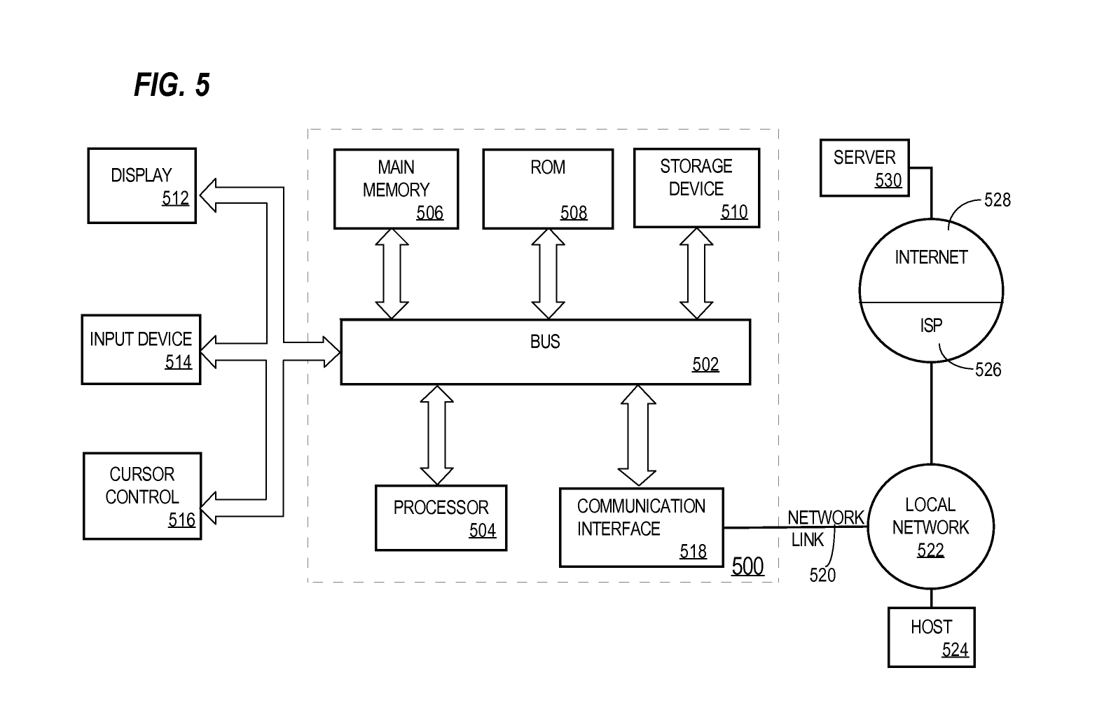

FIG. 5 is a block diagram that depicts a process 500 for generating, training, and using a model for identifying prospects, in an embodiment. Process 500 may be implemented by one or more components of targeted content system 170.

Feature set 510 is provided as input to model generator 530. Feature set 510 may be specified by one or more users.

Training data 520 is provided as input to model generator 530. Training data 520 comprises data about multiple successful and/or unsuccessful users, labeled as such. The data sets in training set 510 may have been gathered over a long period of time or may be restricted to only users that have been “seen” (or received by targeted content system 170) over a relatively recent period of time (e.g., one year).

Model generator 530 analyzes training data 520 based on the features indicated in feature set 510. Output of model generator 530 is model 540.

Before using model 540 to identify prospects, model 540 is validated based on validation data 550, which includes data about multiple users, although the number of users indicated in validation data 550 may be much less (e.g., three times less) than the number of users indicated in training data 520. Model 540 generates validation output 560 that indicates a score for each user indicated in validation data 550.

Although FIG. 5 depicts model 540 as receiving validation data 550 and live data 570, a different version of model 540 may receive and process live data 570 than the version that received and processed validation data 550. Thus, an analysis of validation output 560 may indicate that model 540 is not ready for production or for identifying prospects. Therefore, model generator 530 or another component (not depicted) may refine or further modify model 540.

A score threshold may be selected after model 540 is validated based on analyzing validation output 560. Once an acceptable score threshold is selected, live data 570 (comprising multiple user profiles and/or online behavior of the users) is provided as input to model 540, which produces score 580 for each user. The processing that is used to generate a score using model 540 may be considered a type of comparison between profile data of a potential prospect and profile information (of multiple successful users) that is reflected in model 540 itself.

### Selecting a Score Threshold

As described previously, the model outputs a score. In order to determine whether to categorize the corresponding user as a prospect, the score is interpreted, such as by determining whether the score is greater than (or less than) a particular threshold. If so, then the corresponding user is identified as a prospect and is assigned to a nurture flow associated with the model. Information about the same user may be input into multiple models if multiple models exist. Thus, a single user may be considered a prospect with respect to one nurture flow, but not with respect to another nurture flow.

In an embodiment, a model's score threshold is updatable. For example, later, if emphasis is being placed on targeting content to more users, then the score threshold may be decreased. Alternatively, if monetary resources required to target content to users are depleting, then the score threshold may be increased. Such a modification of the score threshold may be manual or automatic. For example, certain inputs may be used to determine whether to increase or decrease the score threshold.

In an embodiment, a score for each user may be used to rank or prioritize the users relative to each other. For example, the top fifty users in terms of score are identified as prospects.

### Scoring Users Using a Model

In an embodiment, a model is used to rank or score candidates that have already indicated some interest, such as by filling out a form at a marketer's website. For example, information of multiple users is input into the model to determine a score for each user. The information may be user profile data and/or online user behavior data associated with the user.

A user's score may be used in one or more of the following ways. In one approach, a prospect's score is used to determine to which nurture flow (from among multiple nurture flows) the prospect will be assigned. For example, a marketer has established two nurture flows: one for prospects with a score greater than or equal to 0.5 and another for prospects with a score less than 0.5. The two nurture flows may be different in terms of number of segments, the segment advancement criteria, the type of targeted content, and/or number and/or types content delivery channels.

In another approach, a user's score is used to determine to which segment of a nurture flow the candidate will be assigned. For example, users with a score less than 0.33 are assigned to the first segment in a nurture flow, users with a score greater than or equal to 0.33 and less than 0.66 are assigned to the second segment in the nurture flow, and users with a score greater than or equal to 0.66 are assigned to the third segment in the nurture flow.

In another approach, a user's score is used when determining whether to advance the user from one segment to another segment in a nurture flow. For example, segment advancement criteria of a particular segment in the nurture flow may be that a user is to advance to a subsequent segment if (a) (1) a particular advertisement was presented to the user and (2) the user has a score greater than 0.8 or (b) the user has viewed a particular video. As another example, the higher the score, the less time the user is assigned to a particular segment (or to any segment) in a nurture flow.

In another approach, a user's score is used to determine which content to target to the candidate. For example, a targeting parameter of a particular segment in a nurture flow may be that first content is to be displayed to a user if the user's score is greater than or equal to 0.6 and that second content is to be displayed to the user if the user's score is less than 0.6.

In another approach, a user's score is used to determine which content delivery channel to select while the user is assigned to a particular segment in a nurture flow. For example, a first content delivery channel is selected for delivering particular content if a user's score is greater than or equal to 0.5 while a second (different) content delivery channel is selected for delivering the particular content if the user's score is less than 0.5.

In another approach, a user's score is used to determine how many resources to devote to the user. For example, the higher a user's score, the more budget of a recruiting campaign to spend on the user. Conversely, the lower a user's score, the less budget is spent on the user. For example, multiple sponsored updates are presented to users (assigned to a particular segment in a nurture flow) who have a score above 0.7 via a homepage feed provided by the respective user's social network provider, while a single sponsored update is presented to users who have a score below 0.7. Different ranges of scores may correspond to a different amount of money to allocate to users having scores in those ranges.

### Filtering Out Prospects and Potential Prospects

Information about successful users may be used to filter out prospects who are currently assigned to a nurture flow and/or filter out potential prospects who are indicated in a CRM database or are otherwise not yet assigned to a nurture flow. One motivation for filtering out prospects is to save on computing resources and/or monetary resources required to target such prospects. For example, if user A is assigned to a nurture flow and it is determined that user A is unlike any of the successful users of the nurture flow or is unlike the majority of successful users of the nurture flow, then user A is removed from the nurture flow.

As another example, if user B is in a CRM database (e.g., user management system 140), but not yet assigned to a nurture flow and it is determined that user B is unlike a general profile of any nurture flow associated with the entity that manages, owns, or operates the CRM database, then an entry in the CRM database is updated (e.g., by targeted content system 170 sending a message to user management system 140) to indicate that user B is not to be assigned to any nurture flow. In a related example, if user B is determined to be similar to successful users of a particular nurture flow, then an entry in the CRM database is updated to indicate that user B is to be assigned to the particular nurture flow if, for example, certain conditions are satisfied, such as user B advancing to a particular stage in a sales process defined by the entity that manages, owns, or operates the CRM database.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 5 is a block diagram that illustrates a computer system 500 upon which an embodiment may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1. A method comprising:
receiving, over a network from a first computing system, a first user record that includes first data that is about a first user and that is provided by the first user;
retrieving, from an online social network service that is different than the first computing system, using the first data, first profile data, about the first user, that is not included in the first user record and that includes data that the first user provided to the online social network service;
associating the first user with a nurture flow that comprises a plurality of segments, wherein each segment in the plurality of segments is associated with a different set of one or more targeting parameters and a different set of one or more segment advancement criteria;
while the first user is assigned to a first segment of the plurality of segments:
identifying first content based on a first set of one or more targeting parameters that is associated with the first segment,
causing the first content to be presented to the first user by causing the first content to be sent over a second network to a computing device of the first user;
identifying one or more first segment advancement criteria that are associated with the first segment;
determining whether the one or more first segment advancement criteria are satisfied;
in response to determining that the one or more first segment advancement criteria are satisfied, assigning the first user from the first segment to a second segment of the plurality of segments;
while the first user is assigned to the second segment of the plurality of segments;
identifying second content based on a second set of one or more targeting parameters that is associated with the second segment, and
causing the second content to be presented to the first user;
wherein the method is performed by one or more computing devices.

2. The method of claim 1, wherein retrieving the first profile data comprises using the first data to identify a first user profile in a social network that is provided by a social network provider and that is owned or operated by a first entity that is different than a second entity that owns or operates the first computing system.

3. The method of claim 1, further comprising, while the first user is assigned to the second segment:
identifying one or more second advancement criteria that are associated with the second segment and that are different than the one or more first segment advancement criteria;
determining whether the one or more second segment advancement criteria are satisfied;
in response to determining that the one or more second segment advancement criteria are satisfied, assigning the first user to a third segment, in the nurture flow, that is different than the first segment and the second segment.

4. The method of claim 1, further comprising, prior to assigning the first user to the first segment of the nurture flow:
identifying a plurality of nurture flows that includes the nurture flow, wherein each nurture flow in the plurality of nurture flows comprises multiple segments and is associated with a different intended action;
selecting, based on one or more criteria, the nurture flow from among the plurality of nurture flows.

5. The method of claim 4, wherein:
a first intended action associated with a first nurture flow of the plurality of nurture flows is to purchase a first particular product or service;
a second intended action associated with a second nurture flow of the plurality of nurture flows is to purchase a second particular product or service.

6. The method of claim 4, wherein a first nurture flow in the plurality of nurture flows comprises a first number of segments and a second nurture flow in the plurality of nurture flows comprises a second number of segments that is different than the first number of segments.

7. The method of claim 1, wherein:
causing the first content to be presented to the first user comprises sending, over a second network to a first content delivery channel, targeting instruction data that indicates the first user and the first content;
the first content delivery channel uses the targeting instruction data to cause the first content to be presented to the first user that requests web content from an entity associated with the first content delivery channel.

8. The method of claim 7, wherein the targeting instruction data includes the first content.

9. The method of claim 7, wherein a targeting parameter in the first of one or more targeting parameters indicates the first content delivery channel.

10. The method of claim 7, further comprising:
selecting, based on the first profile data, the first content delivery channel, from among a plurality of content delivery channels, to deliver the first content to the first user.

11. The method of claim 7, wherein:
causing the second content to be presented to the first user comprises sending, over the network to a second content delivery channel that is different than the first content delivery channel, second targeting instruction data that indicates the first user and the second content;
the second content delivery channel causes the second content to be presented to the first user.

12. The method of claim 1, wherein the first set of one or more targeting parameters indicate a first content delivery channel through which the first content will be presented to the first user.

13. The method of claim 1, further comprising:
assigning a second user to a particular segment in a second nurture flow;
receiving, from a social network provider, update data that indicates a change in a social profile of the second user;
in response to receiving the update data, assigning the second user to a different segment in the second nurture flow.

14. The method of claim 13, wherein the change is one of:
a new connection or contact, in a social network provided by the social network provider, to the second user;
a change in employment status;
a change in a job title indicated in the social profile; or
a change in a current employer or academic institution.

15. A system comprising:
one or more processors;
one or more computer-readable media storing instructions which, when executed by the one or more processors, cause:
receiving, over a network from a first computing system, a first user record that includes first data that is about a first user and that is provided by the first user;
retrieving, from an online social network service that is different than the first computing system, using the first data, first profile data, about the first user, that is not included in the first user record and that includes data that the first user provided to the online social network service;
associating the first user with a nurture flow that comprises a plurality of segments, wherein each segment in the plurality of segments is associated with a different set of one or more targeting parameters and a different set of one or more segment advancement criteria;
while the first user is assigned to a first segment of the plurality of segments:
identifying first content based on a first set of one or more targeting parameters that is associated with the first segment,
causing the first content to be presented to the first user by causing the first content to be sent over a second network to a computing device of the first user;
identifying one or more first segment advancement criteria that are associated with the first segment;
determining whether the one or more first segment advancement criteria are satisfied;
in response to determining that the one or more first segment advancement criteria are satisfied, assigning the first user from the first segment to a second segment of the plurality of segments;
while the first user is assigned to the second segment of the plurality of segments;
identifying second content based on a second set of one or more targeting parameters that is associated with the second segment, and
causing the second content to be presented to the first user.

16. The system of claim 15, wherein identifying the first profile data comprises using the first data to identify a first user profile in a social network that is provided by a social network provider and that is owned or operated by a first entity that is different than a second entity that owns or operates the first computing system.

17. The system of claim 15, wherein the instructions, when executed by the one or more processors, further cause, while the first user is assigned to the second segment:
identifying one or more second advancement criteria that are associated with the second segment and that are different than the one or more first segment advancement criteria;
determining whether the one or more second segment advancement criteria are satisfied;
in response to determining that the one or more second segment advancement criteria are satisfied, assigning the first user to a third segment, in the nurture flow, that is different than the first segment and the second segment.

18. The system of claim 15, wherein the instructions, when executed by the one or more processors, further cause, prior to assigning the first user to the first segment of the nurture flow:
identifying a plurality of nurture flows that includes the nurture flow, wherein each nurture flow in the plurality of nurture flows comprises multiple segments and is associated with a different intended action;
selecting, based on one or more criteria, the nurture flow from among the plurality of nurture flows.

19. The system of claim 18, wherein:
a first intended action associated with a first nurture flow of the plurality of nurture flows is to purchase a first particular product or service;
a second intended action associated with a second nurture flow of the plurality of nurture flows is to purchase a second particular product or service.

20. The system of claim 18, wherein a first nurture flow in the plurality of nurture flows comprises a first number of segments and a second nurture flow in the plurality of nurture flows comprises a second number of segments that is different than the first number of segments.

21. The method of claim 1, wherein, while the first user is assigned to the first segment, identifying the first content is also based on the first profile data.

22. The method of claim 1, wherein determining whether the one or more first segment advancement criteria are satisfied is based on at least a portion of the first profile data.

23. The method of claim 4, wherein selecting the nurture flow from among the plurality of nurture flows is based on at least a portion of the first profile data.
